(19) United States
(12) Patent Application Publication
(10) Pub. No.: US 2025/0328200 A1
(43) Pub. Date: Oct. 23, 2025

(54) Deformable Stylus and Corresponding Applications and Methods

(71) Applicant: Motorola Mobility LLC, Chicago, IL (US)

(72) Inventors: Amit Kumar Agrawal, Bangalore (IN); Manoj Jain, Bangalore (IN); Jilji N. Elayath, Bangalore (IN)

(21) Appl. No.: 18/639,496

(22) Filed: Apr. 18, 2024

(51) Int. Cl. G06F 3/0354; G06F 3/038; H04R 1/02; H04R 1/10

(52) U.S. Cl. CPC G06F 3/03545; G06F 3/0383; H04R 1/028; H04R 1/1008

(57) ABSTRACT

A deformable stylus has a plurality of deformable sections allowing the deformable stylus to transform between an extended state where a central axis passes through each deformable section of the plurality of deformable sections and an ear-wearable state where at least some deformable sections deform to define an car-receiving hook.

### BACKGROUND

### Technical Field

This disclosure relates generally to electronic devices, and more particularly to deformable electronic devices.

### Background Art

Portable electronic device usage has become ubiquitous. Vast majorities of the population carry a smartphone, tablet computer, or laptop computer daily to communicate with others, stay informed, to consume entertainment, and to manage their lives.

As the technology incorporated into these portable electronic devices has become more advanced, so too has their feature set. A modern smartphone includes more computing power than a desktop computer of only a few years ago. Additionally, while early generation portable electronic devices included physical keypads, most modern portable electronic devices include touch-sensitive displays. While fingers work well as user input devices with the touch-sensitive displays, some users prefer to use a stylus for additional granularity and accuracy in selecting user actuation targets. It would be advantageous to have an improved stylus for use with companion electronic devices.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory deformable stylus, in a non-deformed state, in accordance with one or more embodiments of the disclosure.

FIG. 2 illustrates a user engaging an electronic device with an explanatory deformable stylus configured in accordance with one or more embodiments of the disclosure.

FIG. 3 illustrates one explanatory deformable stylus, in a deformed state, in accordance with one or more embodiments of the disclosure.

FIG. 4 illustrates another deformable stylus, in a non-deformed state, in accordance with one or more embodiments of the disclosure.

FIG. 5 illustrates the explanatory deformable stylus of FIG. 4 in a deformed state.

FIG. 6 illustrates the explanatory deformable stylus of FIG. 5 operating in a hands-free accessory mode of operation.

FIG. 7 illustrates yet another explanatory deformable stylus in accordance with one or more embodiments of the disclosure.

FIG. 8 illustrates still another deformable stylus in accordance with one or more embodiments of the disclosure.

FIG. 9 illustrates one explanatory companion electronic device for a deformable stylus in accordance with one or more embodiments of the disclosure.

FIG. 10 illustrates one explanatory method in accordance with one or more embodiments of the disclosure.

FIG. 11 illustrates another explanatory method in accordance with one or more embodiments of the disclosure.

FIG. 12 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to a deformable stylus comprising a plurality of deformable sections allowing the deformable stylus to transform between an extended state where a central axis passes through each deformable section of the plurality of deformable sections and an ear wearable state where at least some deformable sections deform to define an ear-receiving hook and at least one other deformable section defines an extension extending distally from an end of the ear-receiving hook, thereby allowing the deformable stylus to operate in a hands-free accessory mode of operation. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of, in response to a communication device in a deformable stylus being electronically in communication with a companion electronic device, operate a loudspeaker and microphone of the deformable stylus as a wireless headset when the deformable stylus is mechanically deformed to define an ear-receiving hook and extension extending distally from the ear-receiving hook. The non-processor circuits may include, but are not limited to, a radio receiver, a radio transmitter, signal drivers, clock circuits, power source circuits, and user input devices. As such, these functions may be interpreted as steps of a method to perform operating a deformable stylus as a wireless headset when one or more sensors detect the deformable stylus defining an ear receiver while in communication with a companion electronic device.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide a deformable stylus comprising a plurality of deformable sections allowing the deformable stylus to transform between an extended state where a central axis passes through each deformable section of the plurality of deformable sections and an ear wearable state where at least some of the deformable sections deform to define an ear-receiving hook, with at least one other deformable section defining an extension extending distally from an end of the ear-receiving hook. Advantageously, this allows the deformable stylus to operate as a traditional stylus when in the extended state and in a hands-free accessory mode of operation as a wireless headset when in a deformed state.

Embodiments of the disclosure contemplate that many premium portable electronic devices today include a stylus. Some stylus-enabled devices offer specialized features and functionalities to enhance the user experience. Illustrating by example, a stylus may be able to charge the partner electronic device in some cases. Styluses can also be used to draw or make selections by tapping.

Embodiments of the disclosure also contemplate that even the fanciest touch-sensitive devices have physical limitations due to the width of a user's finger, which can be wider than the various touch-sensitive targets presented on the touch-sensitive device. Accordingly, the granularity with which small objects can be selected can be limited by the surface area of the user's finger. Said differently, a user will find it difficult to accurately select “touchable objects” on a touch-sensitive device must that are spaced closer than, or have a size smaller than, the size of a fingertip. For such situations, the inclusion of a stylus with an electronic device allows for a more accurate and controllable way to deliver user input to a user interface of an electronic device.

Embodiments of the disclosure also contemplate that many portable electronic devices are configured for use with wireless headphones and earbuds. Some users even consider these wireless earpieces to be essential companion electronic devices with a smartphone, as they provide a personal and immersive listening experience. Some ear devices provide active noise cancelation as well.

The problem with separate ear devices is that they are often expensive to purchase. They also create portability issues in that a user has to remember to carry them at all times, so they are available for use. What's more, they are sometimes small and can be easily lost.

Advantageously, embodiments of the disclosure provide a solution to these issues by providing a deformable stylus that can also work as a wireless headset. In one or more embodiments, a deformable stylus comprises one or more deformable body portions separating a plurality of rigid skeletal body segments. In one or more embodiments, right skeletal body segments situated between a first terminal rigid exoskeletal body segment and a second terminal rigid exoskeletal body segment have a trapezoidal cross section.

In one or more embodiments, deformable body portions separating the rigid skeletal body segment situated between the first terminal rigid exoskeletal body segment and the second terminal rigid exoskeletal body segment are configured to deform to cause the rigid skeletal body segments situated between the first terminal rigid exoskeletal body segment and the second terminal rigid exoskeletal body segment to define an ear receiver. When the ear receiver is formed, the deformable stylus can be used as a wireless headset.

Methods can accompany the deformable stylus. Illustrating by example, in one or more embodiments one or more processors of a system determine that the deformable stylus with an embedded microphone and speaker system is wirelessly in communication with a companion electronic device. The one or more processors can determine that an application or service running on the companion electronic device is using audio inputs or audio outputs, such as when an application is playing audio content, video content with accompanying audio, or multimedia content on stylus-enabled devices and initiating or receiving an audio or video call. The one or more processors can optionally detect that the stylus has been withdrawn from a stylus receiver in the companion electronic device.

In one or more embodiments, the one or more processors determine that there are no other wired or wireless audio headsets or headphones in communication with the companion electronic device. In one or more embodiments, when a user transforms the deformable stylus from an extended state to a deformed state, one or more processors within the deformable stylus can activate an on-board speaker and/or microphone so that the deformable stylus can be used as a wireless headset.

When the audio use case is terminated, or when the user returns the deformable stylus to the non-deformed state, the hands-free accessory mode of operation can cease. Advantageously, such a solution optimizes the simultaneous utilization of the deformable stylus as a hands-free headset without requiring the user to carry additional hardware.

In one or more embodiments, a deformable stylus comprises a microphone, a loudspeaker, a communication device, and one or more processors. In one or more embodiments, the one or more processors are configured to, in response to the communication device being electronically in communication with a companion electronic device, operate the loudspeaker and microphone as a wireless headset when the deformable stylus is mechanically deformed to define an ear-receiving hook and extension extending distally from the ear-receiving hook. The one or more processors are configured to cease operating the loudspeaker and microphone as the wireless headset when the deformable stylus is straitened.

As noted above, in one or more embodiments the deformable stylus comprises deformable body portions separating rigid skeletal body segments situated between a first terminal rigid exoskeletal body segment and a second terminal rigid exoskeletal body segment. In one or more embodiments, at least some of the rigid skeletal body segments have different lengths than do other rigid skeletal body segments. When deformable segments between the rigid exoskeletal body segments deform, an ear-receiving hook can be defined to place the deformable stylus in a hands-free accessory mode of operation.

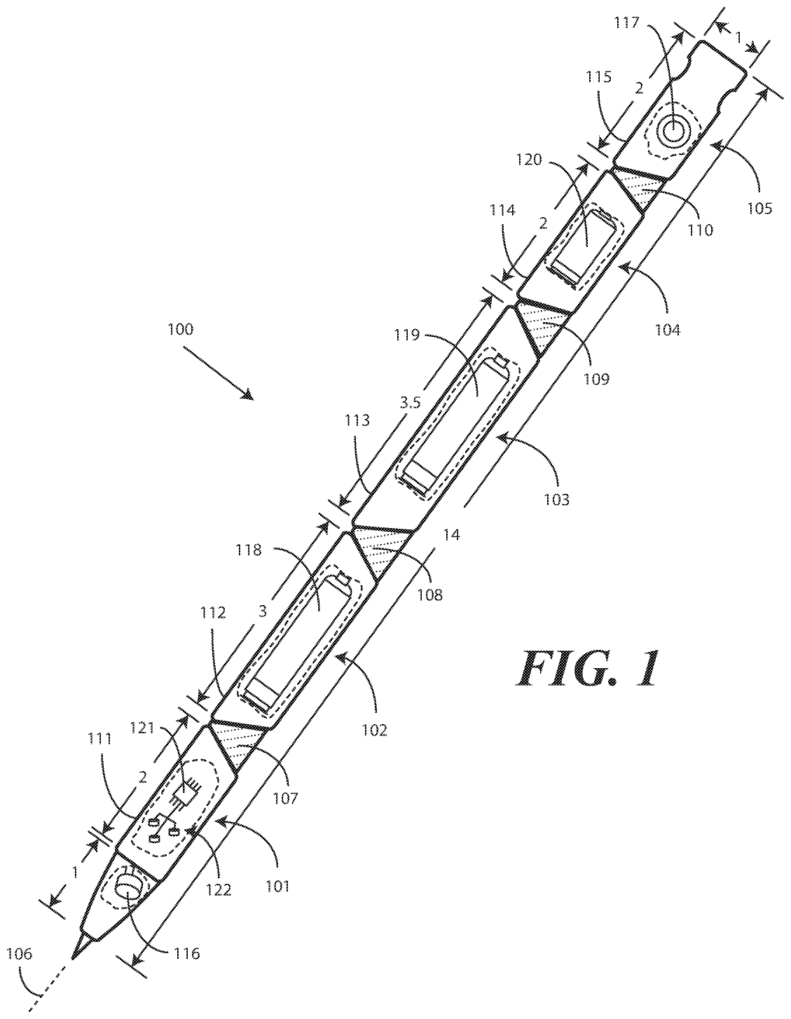

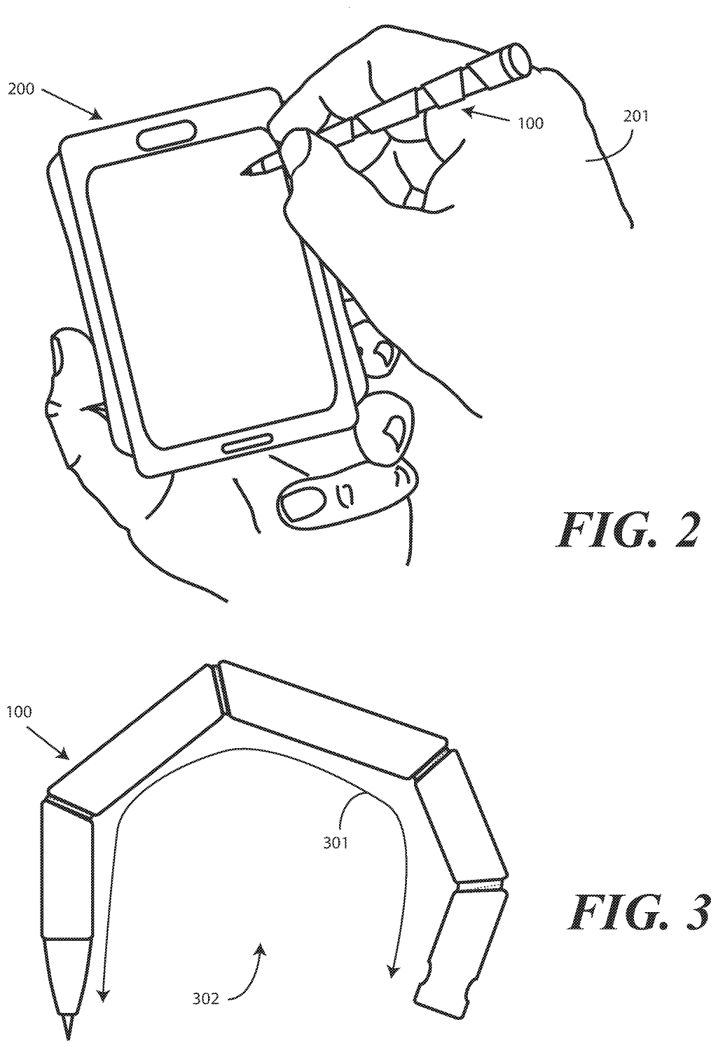

Turning now to FIGS. 1-3, illustrated therein is one explanatory deformable stylus 100 configured in accordance with one or more embodiments of the disclosure. The deformable stylus 100 is shown in an extended state in FIG. 1, with a user 201 using the deformable stylus 100 while in the extended state to interact with a companion electronic device 200 in FIG. 2. Illustrative measurements for the different elements of the deformable stylus 100, all presented in inches, are set forth in FIG. 1 as well.

In one or more embodiments, the deformable stylus 100 comprises a plurality of deformable sections 101, 102, 103, 104, 105 that allow the deformable stylus 100 to transform between an extended state, which is shown in FIGS. 1 and 2, and an ear wearable state, which is shown in FIG. 3. When in the extended state, a central axis 106 passes through each deformable section 101, 102, 103, 104, 105 of the plurality of deformable sections 101, 102, 103, 104, 105. By contrast, when in the deformed state shown in FIG. 3, the deformable stylus 100 defines an ear-receiving hook 301. When deformed to define the ear-receiving hook 301, the deformable stylus 100 is considered to be in an ear-wearable state.

In one or more embodiments, each deformable section 101, 102, 103, 104, 105 comprises one or more deformable body portions 107, 108, 109, 110 separating a plurality of rigid exoskeletal body segments 111, 112, 113, 114, 115. The one or more deformable body portions 107, 108, 109, 110, which could be sections of a single, continuous deformable body section that passes through the plurality of rigid exoskeletal body segments 111, 112, 113, 114, 115, or that can be individual sections of deformable material that separate the plurality of rigid exoskeletal body segments 111, 112, 113, 114, 115, can be manufactured from a bendy material such as wire, thermoplastics, bendable metals, bendable plastics, combinations thereof, or other materials. The plurality of rigid exoskeletal body segments 111, 112, 113, 114, 115 can be manufactured from rigid thermoplastics, metal, wood, or other rigid materials. Other constructions for both the one or more deformable body portions 107, 108, 109, 110 and the plurality of rigid exoskeletal body segments 111, 112, 113, 114, 115 will be obvious to those of ordinary skill in the art having the benefit of this disclosure.

Since rigid exoskeletal body segments 111, 112 are situated at the end of the deformable stylus 100, they are referred to as a first terminal rigid exoskeletal body segment 111 and a second terminal rigid exoskeletal body segment 115, respectively. In this illustrative embodiment, the rigid exoskeletal body segments 112, 113, 114 situated between the first terminal rigid exoskeletal body segment 111 and the second terminal rigid exoskeletal body segment 115 have a trapezoidal cross section. In other embodiments other cross-sectional shapes can be used.

As noted above, in one or more embodiments the deformable body portions 107, 108, 109, 110 separating the rigid exoskeletal body segments 112, 113, 114 situated between the first terminal rigid exoskeletal body segment 111 and the second terminal rigid exoskeletal body segment 115 are configured to deform. This allows the rigid exoskeletal body segments 112, 113, 114 situated between the first terminal rigid exoskeletal body segment 111 and the second terminal rigid exoskeletal body segment 115 to define an ear receiver 302, one example of which is shown in FIG. 3.

In one or more embodiments, a microphone 116 is situated within, and carried by, the first terminal rigid exoskeletal body segment 111. Similarly, a loudspeaker 117 is situated within, and carried by, the deformable stylus 100. In this illustrative embodiment, the loudspeaker 117 is situated within the second terminal rigid exoskeletal body segment 115. However, in other embodiments, the loudspeaker 117 could be situated in other rigid exoskeletal body segments 112, 113, 114. The same is true with the microphone 116—it could be situated in other rigid exoskeletal body segments 112, 113, 114 as well.

In one or more embodiments, the rigid exoskeletal body segments 112, 113, 114 situated between the first terminal rigid exoskeletal body segment 111 and the second terminal rigid exoskeletal body segment 115 can carry energy storage devices. Illustrating by example, in the illustrative embodiment of FIG. 1, each rigid exoskeletal body segment 112, 113, 114 has situated therewithin a battery 118, 119, 120, which may be single use or rechargeable, and that can be used to power the various components in the deformable stylus 100. A flexible circuit board, or sections of rigid circuit board separated by flexible conductors passing through the deformable body portions 107, 108, 109, 110, can be used to couple the various electronic components together.

In one or more embodiments, the deformable stylus 100 comprises one or more processors 121 and one or more sensors 122 operable with the one or more processors 121. The one or more processors 121 and one or more sensors 122 can be operable with the microphone 116 and loudspeaker 117 and can be powered by the batteries 118, 119, 120. As will be described in more detail below, in one or more embodiments the one or more processors 121 are configured to operate the deformable stylus 100 as a wireless headset when the one or more sensors the rigid exoskeletal body segments 112, 113, 114 situated between the first terminal rigid exoskeletal body segment 111 and the second terminal rigid exoskeletal body segment 115 deforming to define the ear receiver 302. Advantageously, this allows the deformable stylus 100 to function as a normal stylus when in the extended state shown in FIGS. 1 and 2, but then, using a wireless communication device that is in communication with a companion electronic device, function as a wireless headset when in the deformed state.

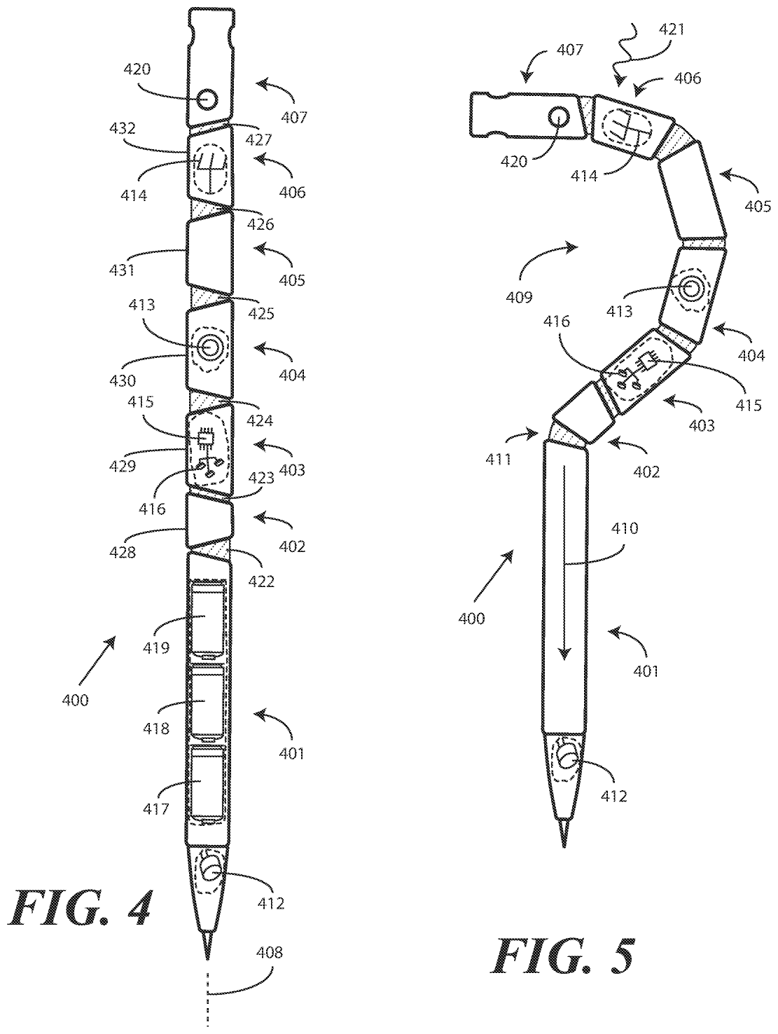

Turning now to FIGS. 4-6, illustrated therein is another deformable stylus 400 configured in accordance with one or more embodiments of the disclosure. As with the deformable stylus (100) of FIG. 1, the deformable stylus 400 of FIGS. 4-6 comprises a plurality of deformable sections 401,402,403,404,405,406,407 that allow the deformable stylus 400 to transform between an extended state, shown in FIG. 4, where a central axis 408 passes through each deformable section 401,402,403,404,405,406,407 and an ear-wearable state where at least some deformable sections 402,403,404,405,406,407 define an ear-receiving hook 409 and at least one deformable section 401 defines an extension 410 extending distally from an end 411 of the ear-receiving hook 409.

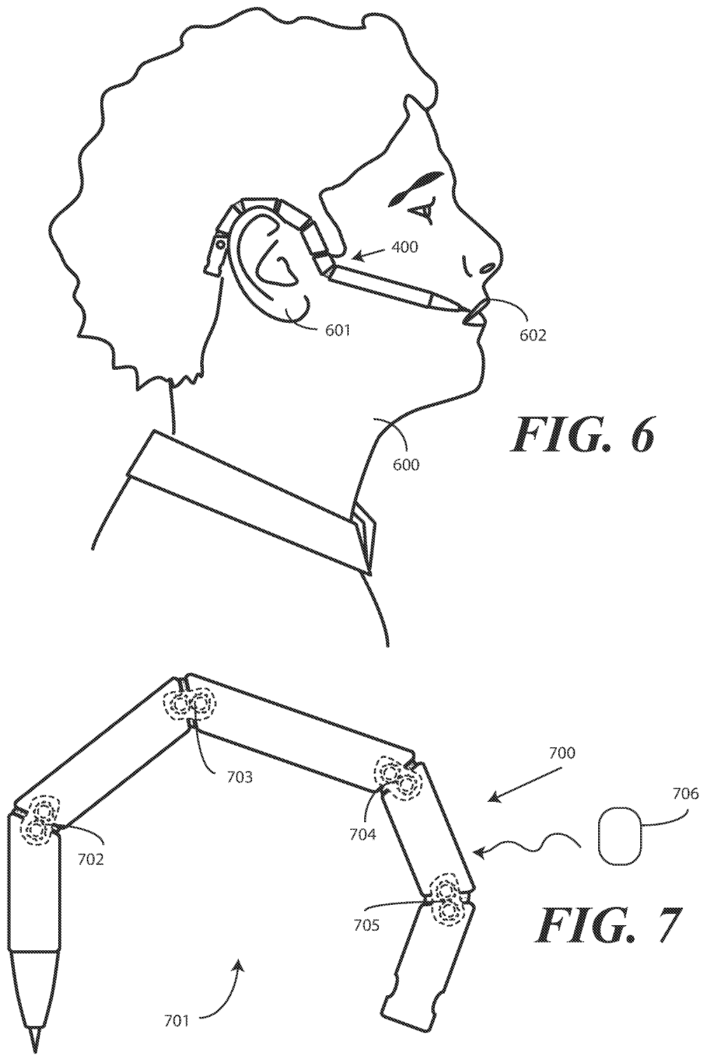

As with the deformable stylus (100) of FIGS. 1-3, the deformable stylus 400 of FIGS. 4-6 has a microphone 412 situated within at least one deformable section 401. Similarly, the deformable stylus 400 comprises a loudspeaker 413 within at least one other deformable section 404. In this illustrative embodiment, the microphone 412 is situated within the deformable section 401 defining the extension 410, while the loudspeaker 413 is situated within one of the deformable sections 404 defining the ear-receiving hook 409. As shown in FIG. 6, when the deformable stylus 400 is worn by a user for use as a wireless headset, this positioning of the loudspeaker (413) and microphone (412) positions the former near the ear 601 of the user 600 and the latter near the mouth 602 of the user. However, other locations for the microphone (412) and the loudspeaker (413) will be obvious to those of ordinary skill in the art having the benefit of this disclosure.

As shown in FIGS. 4-5, in one or more embodiments the deformable stylus 400 also comprises a communication device 414 configured for wireless communication with a companion electronic device (200), one example of which was shown above in FIG. 2. One or more processors 415 and one or more sensors 416 are also situated within the deformable stylus 400. The one or more processors 415 are operable with the one or more sensors 416 and the communication device 414 and can be powered by one or more energy storage devices 417,418,419 carried by the deformable stylus 400. An optional actuator 420, shown here as a power switch, can be used to power ON and OFF the various electronic components.

As described above, in one or more embodiments the one or more processors 415 are configured to operate the microphone 412 and loudspeaker 413 in a hands-free accessory mode of operation when both the deformable stylus 400 is deformed to the ear wearable state and the communication device 414 is receiving electronic communication signals 421 from a companion electronic device (200). In one or more embodiments, the one or more processors 415 are configured to operate the microphone 412 and loudspeaker 413 in the hands-free accessory mode of operation only when the deformable stylus 400 is the only hands-free accessory actively in communication with the companion electronic device (200).

As before, in one or more embodiments the deformable stylus 400 comprises one or more processors 415 operable to detect the geometric configuration of the deformable stylus 400. In one or more embodiments, the one or more processors 415 are configured to cease the hands-free accessory mode of operation when the one or more sensors 416 detect the deformable stylus 400 transitioning from the ear wearable state to the extended state. Of course, the one or more processors 415 can cause the microphone 412 and loudspeaker 413 to cease the hands-free accessory mode of operation when the actuator 420 is actuated as well to turn the deformable stylus 400 OFF.

In this illustrative embodiment, deformable section 401 houses the one or more energy storage devices 417,418,419 and the microphone 412. In one or more embodiments, the one or more energy storage devices 417,418,419 are configured to power the one or more processors 415, the communication device 414, the microphone 412, and the loudspeaker 413.

In one or more embodiments, deformable portions 422,423,424,425,426,427 of the plurality of deformable sections 401,402,403,404,405,406,407 are separated from each other by a non-deformable exoskeletal body segment 428,429,430,431,432. As shown in FIGS. 4-6, an elevation view of at least some non-deformable exoskeletal body segments 428,429,430,431,432 is trapezoidal. As also shown in FIGS. 4-6, in one or more embodiments at least some non-deformable exoskeletal body segments 428,432 have different lengths from other non-deformable exoskeletal body segments 429,430,431. Other configurations will be obvious to those of ordinary skill in the art having the benefit of this disclosure.

In many embodiments, the deformable sections 401,402,403,404,405,406,407 will be manually deformable. As noted above, in one or more embodiments the deformable sections—401,402,403,404,405,406,407 can be manufactured from a bendy material with memory that is operable to retain the deformable stylus 400 in either the extended state or the deformed state as desired by the user 600. However, in other embodiments mechanical actuators can automatically transition a deformable stylus configured in accordance with embodiments of the disclosure between the extended state and the deformed state. Turning now to FIG. 7, illustrated therein is one such deformable stylus 700.

As the deformable styluses (100,400) previously described, in one or more embodiments the deformable stylus 700 comprises a microphone, a loudspeaker, a communication device, and one or more processors. As before, the one or more processors are configured to, in response to the communication device being electronically in communication with a companion electronic device 900), operate the loudspeaker and microphone as a wireless headset when the deformable stylus 700 is mechanically deformed to define an ear-receiving hook 701 and, if configured as the deformable stylus (400) of FIG. 4, an extension (410) extending from the ear-receiving hook 701.

In the illustrative embodiment of FIG. 7, rather than simply having a bendy material with memory serving as the deformable sections, each deformable section comprises mechanical actuators 702,703,704,705. These mechanical actuators 702,703,704,705, which can be motors, geared mechanisms, bimetals that bend in response to temperature, or other devices, are configured to automatically transition the deformable stylus 700 to the ear wearable state in response to the communication device carried by the deformable stylus 700 receiving a deformation command 706 from a companion electronic device (200). In one or more embodiments, the one or more actuators 702,703,704,705 can cause the deformable stylus 700 to return to the extended state in a similar manner, such as when an extension command is received from the companion electronic device (200).

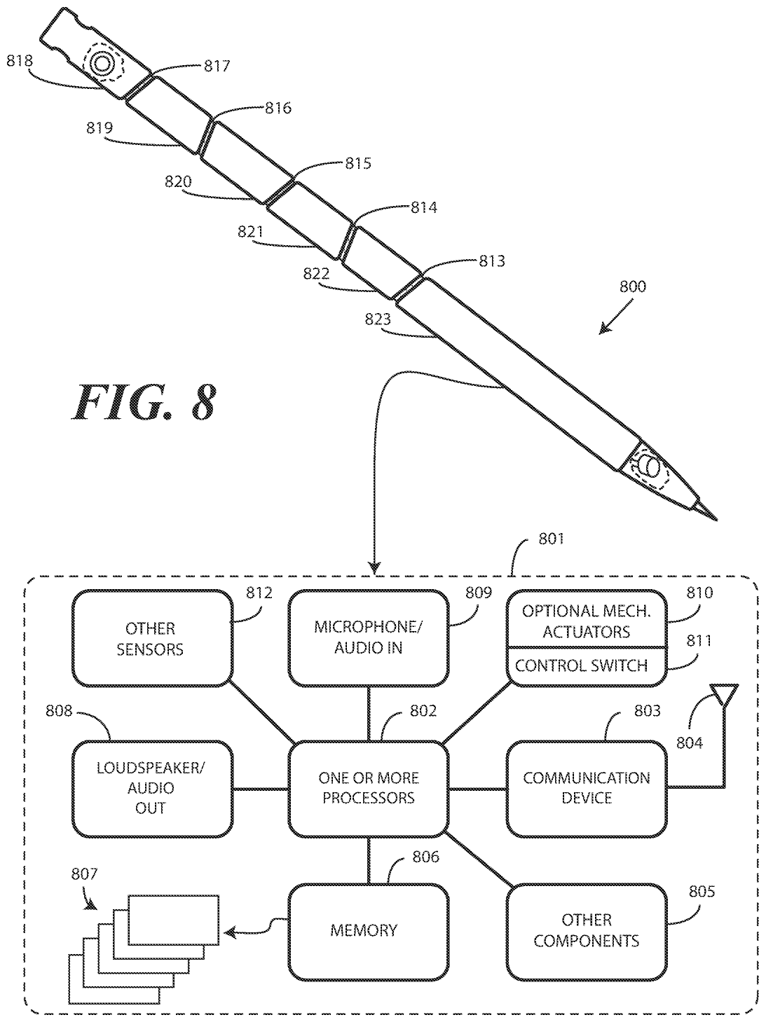

Turning now to FIG. 8, illustrated therein is one explanatory deformable stylus 800 configured in accordance with embodiments of the disclosure. A block diagram schematic 801 of the deformable stylus 800 is also shown in FIG. 8. The block diagram schematic 801 can be configured as a printed and/or flexible circuit board assembly disposed within the deformable body portions 813,814,815,816,817 and rigid skeletal body segments 818,819,820,821,822,823. Various components can be electrically coupled together by conductors, or a bus disposed along one or more printed circuit boards.

In one or more embodiments, the deformable stylus 800 includes one or more processors 802. In one embodiment, the one or more processors 802 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device.

The application processor and the auxiliary processor(s) can be operable with the various components of the deformable stylus 800. Each of the application processor and the auxiliary processor(s) can be configured to process and execute executable software code to perform the various functions of the deformable stylus 800. A storage device, such as memory 806, can optionally store the executable software code used by the one or more processors 802 during operation as one or more modules 807.

The deformable stylus 800 also includes a communication device 803 that can be configured for wired or wireless communication with one or more other devices or networks. The networks can include a wide area network, a local area network, and/or personal area network. The communication device 803 may also utilize wireless technology for communication, such as, but are not limited to, peer-to-peer or ad hoc communications such as HomeRF, near-field communications (NFC), Bluetooth and IEEE 802.11, and other forms of wireless communication such as infrared technology. The communication device 803 can include wireless communication circuitry, one of a receiver, a transmitter, or transceiver, and one or more antennas.

In one embodiment, the one or more processors 802 can be responsible for performing the primary functions of the deformable stylus 800. For example, in one embodiment the one or more processors 802 comprise one or more circuits operable with one or more user interface devices, which can include a control switch 811, to operate in a hands-free accessory mode of operation by transmitting, receiving, and presenting video or other content to and from a companion electronic device. The executable software code used by the one or more processors 802 can be configured as one or more modules 807 that are operable with the one or more processors 802. Such modules 807 can store instructions, control algorithms, logic steps, and so forth.

In one embodiment, the one or more processors 802 may generate commands or execute control operations based upon user input received from one or more sensors 812, which are operable to determine whether the deformable stylus 800 is in an extended state or deformed state. Moreover, the one or more processors 802 may process the received information alone or in combination with other data, such as the information stored in the memory 806.

The deformable stylus 800 can include one or more sensors 812. The one or more sensors 812 may include a microphone 809, an earpiece speaker 808, and/or a second loudspeaker. The one or more other sensors 812 may also include touch actuator selection sensors, flex sensors, proximity sensors, a capacitive touch sensor, and one or more switches. Touch sensors may be used to indicate the deformable stylus 800 is being held by a user. The other sensors 812 can also include audio sensors and video sensors (such as a camera).

Other examples of the one or more sensors 812 include a motion detector, examples of which include an accelerometer, gyroscopes, or other devices, a force sensor configured to detect contact with either the housing of the deformable stylus 800, an intelligent imager configured to capture an image of an object and determine whether the object matches predetermined criteria, an audio capture device having one or more microphones to receive acoustic input, or other sensors. This list is illustrative only and is not comprehensive. Numerous other sensors could be added as will be obvious to those of ordinary skill in the art having the benefit of this disclosure.

Other components 805 operable with the one or more processors 802 can include output components such as video outputs, audio outputs, and/or mechanical outputs. Examples of output components include audio outputs such as speaker port, earpiece speaker, or other alarms and/or buzzers and/or a mechanical output component such as vibrating or motion-based mechanisms. Still other components will be obvious to those of ordinary skill in the art having the benefit of this disclosure.

The other components 805 can also include one or more actuators 810. In one or more embodiments, the one or more actuators 810 are configured to automatically transition the deformable stylus 800 to the ear-wearable state in response to the communication device 804 receiving a deformation command from the companion electronic device.

It is to be understood that FIG. 8 is provided for illustrative purposes only and for illustrating components of one deformable stylus 800 in accordance with embodiments of the disclosure and is not intended to be a complete schematic diagram of the various components required for a deformable stylus. Therefore, other deformable styluses in accordance with embodiments of the disclosure may include various other components not shown in FIG. 8 or may include a combination of two or more components or a division of a particular component into two or more separate components, and still be within the scope of the present disclosure.

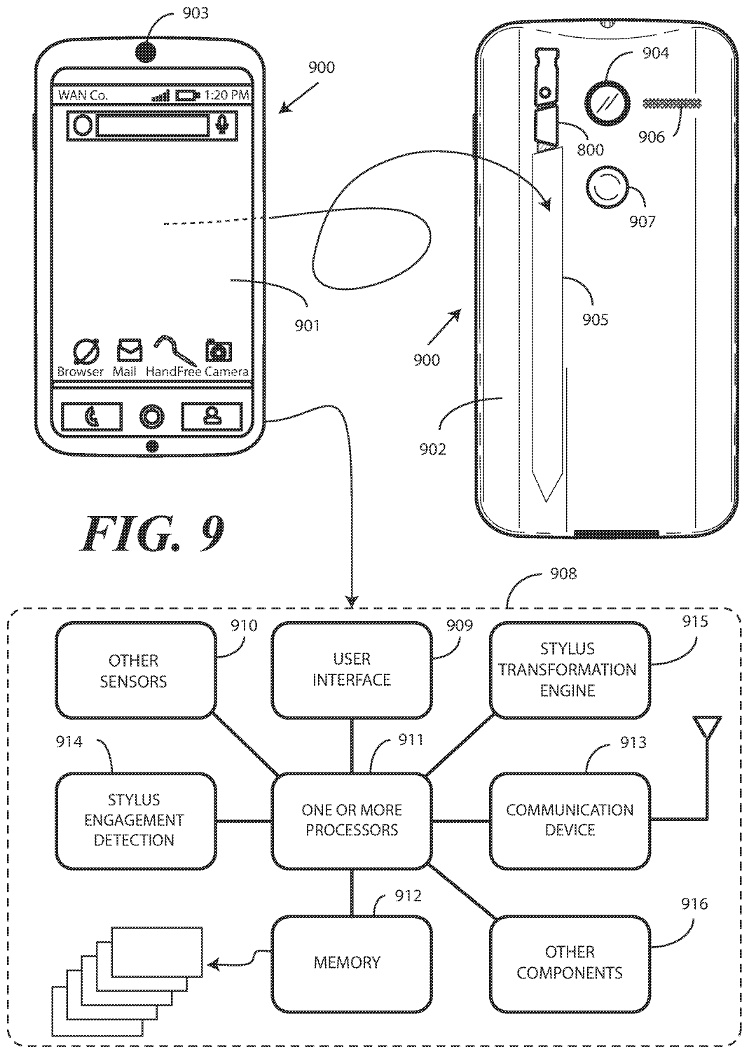

Turning now to FIG. 9, illustrated therein is one explanatory companion electronic device 900 operable with a deformable stylus 800 configured in accordance with one or more embodiments of the disclosure. For illustration purposes, the companion electronic device 900 of FIG. 9 is configured as a smartphone. Embodiments of the disclosure contemplate that the companion electronic device 900 could be configured as other devices as well, including as a tablet computer, a dedicated voice assistant device, a gaming device, a multimedia device, or other device. Other types of electronic devices will be obvious to those of ordinary skill in the art having the benefit of this disclosure.

The companion electronic device 900 of FIG. 9 includes a display 901, which may optionally be touch-sensitive. In an embodiment where the display 901 is touch-sensitive, users can deliver user input to the display 901 as touch input from a finger, a deformable stylus 800, or other objects disposed proximately with the display 901. In one embodiment, the display 901 is configured as an active-matrix organic light emitting diode display. However, it should be noted that other types of displays, including liquid crystal displays, would be obvious to those of ordinary skill in the art having the benefit of this disclosure.

The explanatory companion electronic device 900 of FIG. 9 includes a housing 902. Features can be incorporated into the housing 902. Examples of such features include a front-facing camera or imager 903, a rear-facing camera or imager 904, a sheath 905 for a deformable stylus 800, one or more microphones, and/or an optional speaker port 906. User interface components 907, which may be configured as a button, touch sensor, or touch sensitive surface, can also be disposed along housing members defining the housing 902.

Also illustrated in FIG. 9 is one explanatory block diagram schematic 908 of the companion electronic device 900. In one or more embodiments, the block diagram schematic 908 is configured as a printed circuit board assembly disposed within the housing 902 of the companion electronic device 900. Various components can be electrically coupled together by conductors, or a bus disposed along one or more printed circuit boards. It should be noted that the block diagram schematic 908 includes many components that are optional, but which are included in an effort to demonstrate how varied electronic devices configured in accordance with embodiments of the disclosure can be. Thus, it is to be understood that the block diagram schematic 908 of FIG. 9 is provided for illustrative purposes only and for illustrating components of one companion electronic device 900 in accordance with embodiments of the disclosure.

The block diagram schematic 908 of FIG. 9 is not intended to be a complete schematic diagram of the various components required for a companion electronic device 900. Therefore, other electronic devices in accordance with embodiments of the disclosure may include various other components not shown in FIG. 9 or may include a combination of two or more components or a division of a particular component into two or more separate components, and still be within the scope of the present disclosure.

The illustrative block diagram schematic 908 includes a user interface 909. In one or more embodiments, the user interface 909 includes the display 901 and one or more other sensors 910, which may include a touch sensor, proximity sensor, depth imager, or other type of sensor.

In one embodiment, the companion electronic device 900 includes one or more processors 911. In one embodiment, the one or more processors 911 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device.

The application processor and the auxiliary processor(s) can be operable with the various components of the block diagram schematic 908. Each of the application processor and the auxiliary processor(s) can be configured to process and execute executable software code to perform the various functions of the companion electronic device 900 with which the block diagram schematic 908 operates. A storage device, such as memory 912, can optionally store the executable software code used by the one or more processors 911 during operation.

In this illustrative embodiment, the block diagram schematic 908 also includes a communication circuit 913 that can be configured for wired or wireless communication with one or more other devices or networks. The networks can include a wide area network, a local area network, and/or personal area network. The communication circuit 913 may also utilize wireless technology for communication, such as, but are not limited to, peer-to-peer or ad hoc communications and other forms of wireless communication such as infrared technology. The communication circuit 913 can include wireless communication circuitry, one of a receiver, a transmitter, or transceiver, and one or more antennas.

In one embodiment, the one or more processors 911 can be responsible for performing the primary functions of the electronic device with which the block diagram schematic 908 is operational. For example, in one embodiment the one or more processors 911 comprise one or more circuits operable with the user interface 909 to present presentation information to a user. Additionally, the one or more processors 911 can be operable with the audio output device to deliver audio output to a user. The executable software code used by the one or more processors 911 can be configured as one or more modules that are operable with the one or more processors 911. Such modules can store instructions, control algorithms, and so forth.

In one or more embodiments, a stylus detection engagement engine 914 is configured to determine when a deformable stylus 800 is electronically in communication with the communication device 913. In one or more embodiments, the stylus detection engagement engine 914 is configured to determine whether the deformable stylus 800 is the only audio output device electronically in communication with the deformable stylus 800.

Where the deformable stylus 800 is configured with mechanical actuators (810), a stylus transformation engine 915 can be configured to deliver a deformation command causing the deformable stylus 800 to automatically transition to a deformed state. Similarly, the stylus transformation engine 915 can deliver an extension command to the deformable stylus 800 causing it to return to the extended state as well. Where the deformable stylus 800 is only manually deformable, the stylus transformation engine 915 can determine whether the deformable stylus 800 is deformed or extended from communication signals received from the deformable stylus 800 via the communication device 913.

In one or more embodiments, the stylus engagement detection engine 914 and/or the stylus transformation engine 915 are operable with the one or more processors 911. In some embodiments, the one or more processors 911 can control the stylus engagement detection engine 914 and/or the stylus transformation engine 915. In other embodiments, the stylus engagement detection engine 914 and/or the stylus transformation engine 915 can operate independently, delivering information gleaned from detecting conditions of the companion electronic device 900 and other contextual information to the one or more processors 911. The stylus engagement detection engine 914 and/or the stylus transformation engine 915 can receive data from one or more sensors 910. In one or more embodiments, the one or more processors 911 are configured to perform the operations of the stylus engagement detection engine 914 and/or the stylus transformation engine 915.

Other components 916 operable with the one or more processors 911 can include output components such as video outputs, audio outputs, and/or mechanical outputs. Examples of output components include audio outputs such as speaker port, earpiece speaker, or other alarms and/or buzzers and/or a mechanical output component such as vibrating or motion-based mechanisms. Still other components will be obvious to those of ordinary skill in the art having the benefit of this disclosure.

The other components 916 can also include an audio input/processor. The audio input/processor can include hardware, executable code, and speech monitor executable code in one embodiment. The audio input/processor can include, stored in memory 912, basic speech models, trained speech models, or other modules that are used by the audio input/processor to receive and identify voice commands that are received with audio input captured by an audio input/processor, one example of which is a microphone of the one or more sensors 910. In one embodiment, the audio input/processor can include a voice recognition engine. Regardless of the specific implementation utilized in the various embodiments, the audio input/processor can access various speech models to identify speech commands in one or more embodiments.

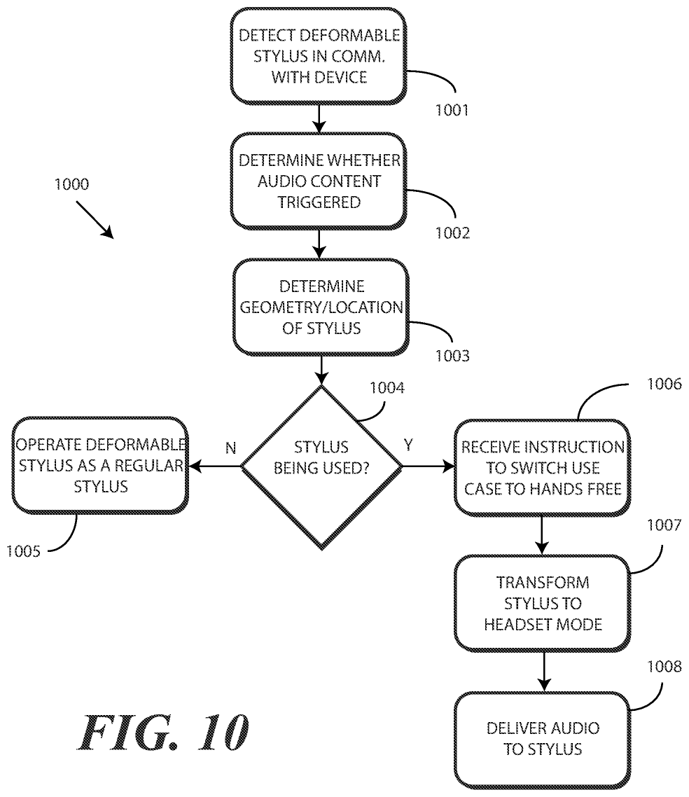

Turning now to FIG. 10, illustrated therein is one explanatory method 1000 for using a deformable stylus in accordance with one or more embodiments of the disclosure. The method 1000 could be implemented in a companion electronic device to allow a user to use a deformable stylus configured in accordance with one or more embodiments of the disclosure as a wireless headset.

Beginning at step 1001, one or more processors of the companion electronic device determine, using a communication device, that a deformable stylus configured in accordance with one or more embodiments of the disclosure is electronically in communication with the companion electronic device. Step 1002 determines whether the output of audio content is triggered in the companion electronic device. Step 1002 would determine that the output of audio content is indeed triggered when, for example, a music player application is playing music, a videoconference application is engaged in a videoconference with audio associated therewith, when a video player is playing video with audio, and so forth.

Step 1003 determines the geometry and location of the deformable stylus. Embodiments of the disclosure contemplate that some companion electronic devices can include a sheath for the deformable stylus, as did the companion electronic device (900) of FIG. 9 above. Embodiments of the disclosure also contemplate that a user is unlikely to use a deformable stylus in a hands-free accessory mode of operation when it is situated in the sheath. However, when removed from the sheath, a user may indeed want to use the deformable stylus in the hands-free accessory mode of operation. Similarly, when the deformable stylus is in the extended state, a user may be using it as a stylus. By contrast, when deformed to the deformed state, this actuates the hands-free accessory mode of operation in one or more embodiments, so that the user can use the deformable stylus as a wireless headset as shown above in FIG. 6.

Using this information, decision 1004 determines whether the deformable stylus is being used as a stylus. The inputs to decision 1004, which include the location of the deformable stylus and the geometric form factor of the deformable stylus, can also include whether a user interface of the companion electronic device, one example of which is a touch-sensitive display, is actively receiving input from the deformable stylus. Other factors to determine whether the deformable stylus is being used as a stylus will be obvious to those of ordinary skill in the art having the benefit of this disclosure.

Where decision 1004 determines that the deformable stylus is being used as a stylus, step 1005 comprises receiving stylus input from the deformable stylus. By contrast, where decision 1004 determines that the deformable stylus is available to be used in a hands-free accessory mode of operation, step 1006 awaits an instruction from the user to cause the companion electronic device to operate in a hands-free mode of operation. Step 1007 comprises causing the deformable stylus to operate in a hands-free accessory mode of operation. In one or more embodiments, this step 1007 comprises communicating a hands-free accessory mode of operation initiation command to one or more processors of the deformable stylus. Step 1008 then comprises delivering audio to the deformable stylus so it can be used as a wireless headset. Step 1008 can also comprise receiving audio signals from a microphone carried by the deformable stylus as well.

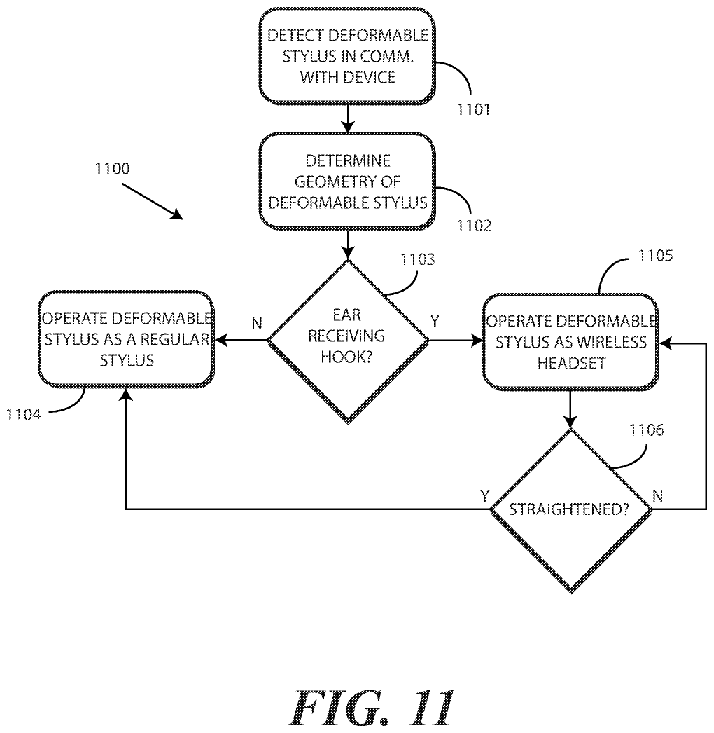

Turning now to FIG. 11, illustrated therein is another method 1100 of using a deformable stylus configured in accordance with one or more embodiments of the disclosure. The method 1100 of FIG. 11 can be implemented using one or more processors of a deformable stylus.

At step 1101, the one or more processors of the deformable stylus determine whether a communication device of the deformable stylus is electronically in communication with a companion electronic device. Step 1102 uses one or more sensors of the deformable stylus to determine the geometric configuration of the deformable stylus, and in particular whether the deformable stylus is in an extended state where a central axis passes through all deformable segments of the deformable stylus or, alternatively, in a deformed state that defines an ear hook and, optionally, an extension extending distally from the ear hook. Whether the ear hook is defined is determined at decision 1103.

If the deformable stylus is in an extended state, step 1104 includes operating the deformable stylus in a stylus mode of operation. By contrast, when the deformable stylus is in a deformed state defining an ear hook, step 1105 comprises operating the deformable stylus in a hands-free accessory mode of operation. When the deformable stylus is operating in the hands-free accessory mode of operation, a user can cause this wireless earpiece mode of operation to cease by straightening the deformable stylus, as determined by decision 1106. As an alternative to straightening the deformable stylus, in other embodiments decision 1106 can determine whether an actuator is actuated to cause the hands-free accessory mode of operation to cease as well. Other techniques for ceasing the hands-free accessory mode of operation will be obvious to those of ordinary skill in the art having the benefit of this disclosure.

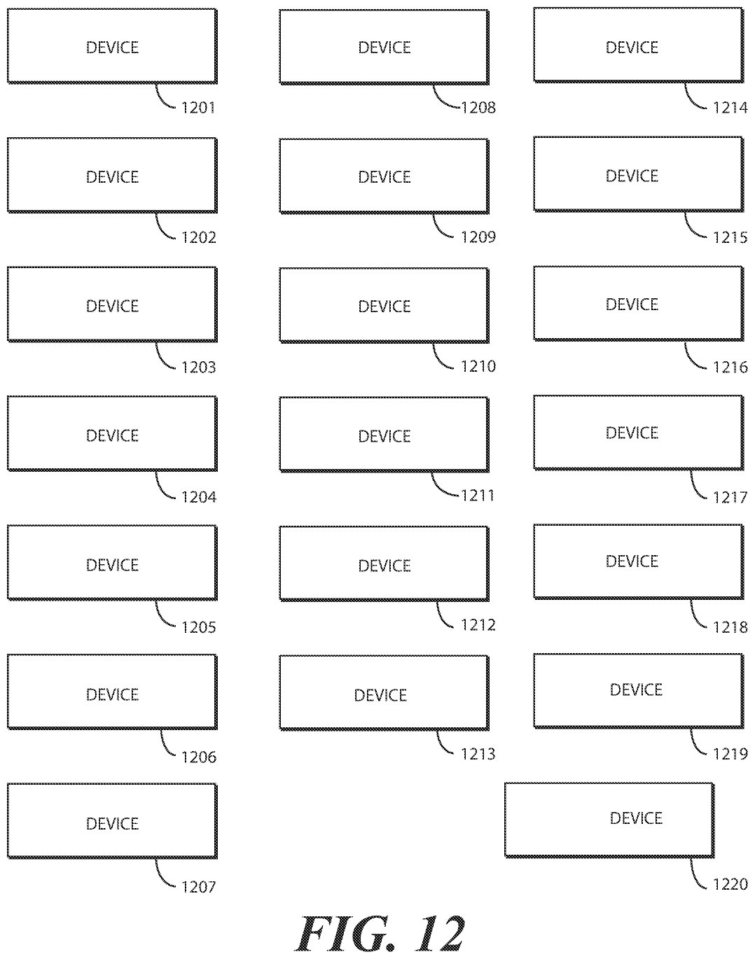

Turning now to FIG. 12, illustrated therein are various embodiments of the disclosure. The embodiments of FIG. 12 are shown as labeled boxes in FIG. 12 due to the fact that the individual components of these embodiments have been illustrated in detail in FIGS. 1-11, which precede FIG. 12. Accordingly, since these items have previously been illustrated and described, their repeated illustration is no longer essential for a proper understanding of these embodiments. Thus, the embodiments are shown as labeled boxes.

At 1201, a deformable stylus comprises a plurality of deformable sections allowing the deformable stylus to transform between an extended state where a central axis passes through each deformable section of the plurality of deformable sections and an ear-wearable state where at least some deformable sections deform to define an ear-receiving hook and at least one other deformable section defines an extension extending distally from an end of the ear-receiving hook. At 1202, the deformable stylus of 1201 further comprises a microphone situated within the at least one deformable section and a loudspeaker situated within a deformable section of the at least some deformable sections.

At 1203, the deformable stylus of 1202 further comprises a communication device and one or more processors situated within the deformable stylus. At 1203, the one or more processors are configured to operate the microphone and loudspeaker in a hands-free accessory mode of operation when both the deformable stylus is deformed to the ear-wearable state and the communication device is receiving electronic communication signals from a companion electronic device.

At 1204, the one or more processors of 1203 are configured to operate the microphone and loudspeaker in the hands-free accessory mode of operation only when the deformable stylus is the only hands-free accessory actively in communication with the companion electronic device. At 1205, the deformable stylus of 1203 further comprises one or more sensors operable to detect a geometric configuration of the deformable stylus. At 1205, the one or more processors are configured to cease the hands-free accessory mode of operation when the one or more sensors detect the deformable stylus transitioning from the ear-wearable state to the extended state.

At 1206, the deformable stylus of 1203 further comprises one or more mechanical actuators configured to automatically transition the deformable stylus to the ear-wearable state in response to the communication device receiving a deformation command from the companion electronic device. At 1207, the deformable stylus of 1203 further comprises one or more energy storage devices situated within one or more deformable sections. At 1207, the one or more energy storage devices are configured to power the one or more processors, the communication device, the microphone, and the loudspeaker.

At 1208, the deformable stylus of 1207 further comprises an actuator carried by a terminal deformable section of the plurality of deformable sections operable to actuate the one or more processors. At 1209, the deformable portions of the plurality of deformable sections of 1201 are separated from each other by a non-deformable exoskeletal body segment. At 1210, an elevation view of at least some non-deformable exoskeletal body segments of 1209 is trapezoidal with at least two non-deformable exoskeletal body segments having different lengths.

At 1211, a deformable stylus comprises one or more deformable body portions separating a plurality of rigid exoskeletal body segments, wherein rigid skeletal body segments situated between a first terminal rigid exoskeletal body segment and a second terminal rigid exoskeletal body segment have a trapezoidal cross section. At 1212, the deformable body portions of 1211 separating the rigid exoskeletal body segments situated between the first terminal rigid exoskeletal body segment and the second terminal rigid exoskeletal body segment are configured to deform to cause the rigid exoskeletal body segments situated between the first terminal rigid exoskeletal body segment and the second terminal rigid exoskeletal body segment to define an ear receiver.

At 1213, the deformable stylus of 1212 further comprises a microphone carried by the first terminal rigid exoskeletal body segment. At 1214, the deformable stylus of 1213 further comprises a loudspeaker carried by the deformable stylus. At 1215, the loudspeaker of 1214 is carried by the second terminal rigid exoskeletal body segment.

At 1216, the deformable stylus of 1214 further comprises one or more sensors and one or more processors operable with the microphone, the loudspeaker, and the one or more sensors. At 1216, the one or more processors are configured to operate the deformable stylus as a wireless headset when the one or more sensors detect the rigid exoskeletal body segments situated between the first terminal rigid exoskeletal body segment and the second terminal rigid exoskeletal body segment deforming to define the ear receiver.

At 1217, a deformable stylus comprises a microphone, a loudspeaker, a communication device, and one or more processors. At 1217, the one or more processors are configured to, in response to the communication device being electronically in communication with a companion electronic device, operate the loudspeaker and microphone as a wireless headset when the deformable stylus is mechanically deformed to define an ear-receiving hook and extension extending from the ear-receiving hook.

At 1218, the one or more processors of 1217 are configured to cease operating the loudspeaker and microphone as the wireless headset when the deformable stylus is straightened. At 1219, the deformable stylus of 1217 stylus comprises deformable body portions separating the rigid skeletal body segments situated between the first terminal rigid exoskeletal body segment and the second terminal rigid exoskeletal body segment. At 1220, at least some of the rigid skeletal body segments of 1219 have different lengths than do at least some others of the rigid skeletal body segments.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. For example

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

1. A deformable stylus comprising a plurality of deformable sections allowing the deformable stylus to transform between an extended state where a central axis passes through each deformable section of the plurality of deformable sections and an ear-wearable state where at least some deformable sections deform to define an ear-receiving hook and at least one other deformable section defines an extension extending distally from an end of the ear-receiving hook, further comprising a microphone situated within a deformable section of the extension and a loudspeaker situated within another deformable section of the ear-receiving hook that is separate from the deformable section of the extension.

2. The deformable stylus of claim 1, wherein the deformable section defines a first end of the deformable stylus, and the another deformable section defines a second end of the deformable stylus separated from the first end by multiple deformable sections further comprising a microphone situated within the at least one other deformable section and a loudspeaker situated within a deformable section of the at least some deformable sections.

3. The deformable stylus of claim 2, further comprising a communication device and one or more processors situated within the deformable stylus, wherein the one or more processors are configured to operate the microphone and loudspeaker in a hands-free accessory mode of operation when both the deformable stylus is deformed to the ear-wearable state and the communication device is receiving electronic communication signals from a companion electronic device.

4. The deformable stylus of claim 3, wherein the one or more processors are configured to operate the microphone and loudspeaker in the hands-free accessory mode of operation only when the deformable stylus is the only hands-free accessory actively in communication with the companion electronic device.

5. The deformable stylus of claim 3, further comprising one or more sensors operable to detect a geometric configuration of the deformable stylus, wherein the one or more processors are configured to cease the hands-free accessory mode of operation when the one or more sensors detect the deformable stylus transitioning from the ear-wearable state to the extended state.

6. The deformable stylus of claim 3, further comprising one or more mechanical actuators configured to automatically transition the deformable stylus to the ear-wearable state in response to the communication device receiving a deformation command from the companion electronic device.

7. The deformable stylus of claim 3, further comprising one or more energy storage devices situated within one or more deformable sections, wherein the one or more energy storage devices are configured to power the one or more processors, the communication device, the microphone, and the loudspeaker.

8. The deformable stylus of claim 7, further comprising an actuator carried by a terminal deformable section of the plurality of deformable sections operable to actuate the one or more processors.

9. The deformable stylus of claim 1, wherein deformable portions of the plurality of deformable sections are separated from each other by a non-deformable exoskeletal body segment.

10. The deformable stylus of claim 9, wherein an elevation view of at least some non-deformable exoskeletal body segments is trapezoidal with at least two non-deformable exoskeletal body segments having different lengths.

11. A deformable stylus, comprising one or more deformable body portions separating a plurality of rigid exoskeletal body segments, wherein rigid skeletal body segments situated between a first terminal rigid exoskeletal body segment and a second terminal rigid exoskeletal body segment have a trapezoidal cross section.

12. The deformable stylus of claim 11, wherein the deformable body portions separating the rigid exoskeletal body segments situated between the first terminal rigid exoskeletal body segment and the second terminal rigid exoskeletal body segment are configured to deform to cause the rigid exoskeletal body segments situated between the first terminal rigid exoskeletal body segment and the second terminal rigid exoskeletal body segment to define an ear receiver.

13. The deformable stylus of claim 12, further comprising a microphone carried by the first terminal rigid exoskeletal body segment.

14. The deformable stylus of claim 13, further comprising a loudspeaker carried by the deformable stylus.

15. The deformable stylus of claim 14, wherein the loudspeaker is carried by the second terminal rigid exoskeletal body segment.

16. The deformable stylus of claim 14, further comprising one or more sensors and one or more processors operable with the microphone, the loudspeaker, and the one or more sensors, wherein the one or more processors are configured to operate the deformable stylus as a wireless headset when the one or more sensors detect the rigid exoskeletal body segments situated between the first terminal rigid exoskeletal body segment and the second terminal rigid exoskeletal body segment deforming to define the ear receiver.

17. A deformable stylus, comprising:
deformable body portions separating rigid exoskeletal body segments situated between a first terminal rigid exoskeletal body segment and a second terminal rigid exoskeletal body segment;
a microphone situated within the first terminal rigid exoskeletal body segment;
a loudspeaker situated within the second terminal rigid exoskeletal body segment;
a communication device; and
one or more processors;
wherein the one or more processors are configured to, in response to the communication device being electronically in communication with a companion electronic device, operate the loudspeaker and microphone as a wireless headset when the deformable stylus is mechanically deformed to define an ear-receiving hook and extension extending from the ear-receiving hook.

18. The deformable stylus of claim 17, wherein the one or more processors are configured to cease operating the loudspeaker and microphone as the wireless headset when the deformable stylus is straightened.

19. The deformable stylus of claim 17, wherein the communication device and the one or more processors are situated in one or more deformable body portions situated between the separating rigid exoskeletal first terminal rigid exoskeletal body segment and the second terminal rigid exoskeletal body segment.

20. The deformable stylus of claim 19, wherein at least some of the rigid exoskeletal body segments have different lengths than do at least some others of the rigid exoskeletal body segments.
